(19) United States
(12) Patent Application Publication
(10) Pub. No.: US 2023/0288343 A1
(43) Pub. Date: Sep. 14, 2023

(54) DEVICE AND METHOD FOR TRANSMISSION INSPECTION OF CONTAINERS HAVING AT LEAST ONE LIGHT-EMITTING DIODE LIGHT SOURCE

(71) Applicant: TIAMA, Saint-Genis-Laval (FR)

(72) Inventors: Laurent COSNEAU, SOUCIEU-EN-JARREST (FR); Pascal FILLON, GREZIEU LA VARENNE (FR)

(21) Appl. No.: 18/016,698

(22) PCT Filed: Jul. 22, 2021
(86) PCT No.: PCT/FR2021/051373

§ 371 Date: Jan. 18, 2023

(30) Foreign Application Priority Data
Jul. 29, 2020 (FR) FR2008027

(51) Int. Cl. G01N 21/90; G01N 21/88

(52) U.S. Cl. CPC G01N 21/90; G01N 21/8806; G01N 2021/8845

(57) ABSTRACT

The invention relates to a device for inspecting in transmission glass-wall containers (2) including at least one driven elementary source (5) constituted by a light-emitting diode (6) with at least two juxtaposed dies (7) emitting light radiation in different spectral emission bands which are a function of the transmission spectra of families of glass container tints, each spectral emission band of a die being limited to a spectral transmission band (Zt) suitable for the inspection in transmission for at least one family of glass container tints, excluding the spectral absorption bands (Za) for this family of glass container tints and in that the device comprises an electronic power supply device (15) independently controlling each die (7) of each elementary source (3).

### TECHNICAL FIELD

The present invention relates to the technical field of inspection in transmission of empty glass containers, such as bottles, jars, flasks, for example, in order to detect possible defects.

The present invention more specifically relates to the light sources used in the context of the inspection in transmission of empty glass containers.

### PRIOR ART

In the state of the art, it is known to inspect glass containers in transmission, that is to say to observe them by a through light. According to such inspection methods, a light source emits light radiation which illuminates the container such that the light penetrates the thickness of the wall of the container and then comes out therefrom, possibly undergoing a modification whose analysis allows deducing a quality of the container.

In addition, the light sources must allow inspecting containers with different tints of glass. Thus, light sources must take into account the spectral absorption of the glass which is a function of the wavelength giving the percentage of light absorbed per mm of traversed glass, considering that the spectral absorption of the glass depends on the glass tint.

The inspection in transmission or by a through light therefore consists in creating and observing the modifications such as, for example, the deflection of light by reflection on a defect such as a surface crack, the deflection of light by refraction on a defect such as a ply or a bad distribution of glass creating parallelism deviations between the inner face and the outer face, the absorption of light by dirt or an internal foreign body, the absorption of light by the glass varying with the traversed glass thickness.

Typically, at least one light sensor collects the light coming from the source and having penetrated the wall of the container. The light sensors are generally linear or matrix cameras associated with optical systems such as objective lenses, prisms or mirrors for example. In some cases, the light sensor only receives light when a defect is present. In other cases, the light sensor receives light in the absence of defect. In all cases, the light collected by the light sensor passes through a glass thickness of the container corresponding to only part of the glass wall or to the entire glass wall.

The “dark field” observation is thus known so that the light sensor only receives light in the presence of a defect, such as to detect surface cracks for example. It is recalled that to detect surface cracks, a region of the container is illuminated, under precise incidences, by means of projectors emitting, in the direction of said region, directed (convergent or slightly divergent) light beams. The directed light beams reach the surface of the container at a precise incidence such that the major part of the beam penetrates the glass wall and propagates in the glass. If a surface crack is present on the light path in the wall, then the surface crack reflects the beam which goes in a modified direction to exit the wall at a precise exit angle, which is a function of the incident angle and of the position and shape of the surface crack. The region illuminated by means of light sensors is observed at precise observation angles adapted to the exit angles of the beams reflected by the surface cracks.

The projectors emitting point or quasi-point directed light beams can be made in various ways. For example, patent EP 1 147 405 proposes implementing illumination heads each emitting a focused and/or colimated light beam or ray. These illumination heads are each connected by optical fibers to a halogen lamp. In this patent, a large number of light sources and image sensors which cooperate by transmitter/receiver pairs are used. In order to avoid interference between transmitter/receiver pairs, it is provided to use several colors to achieve a decoupling, for example red for some sources, with the associated receivers sensitive to red and blue for other transmitter/receiver pairs. The person skilled in the art understands that these two colors are chosen to create a decoupling and therefore chosen such that their respective spectra are disjoint. This patent therefore does not propose a solution for inspecting containers with different tints. Patent EP 3 118 609 proposes making the light source using a first, a second and a third laser source with different wavelengths, associated with optical structures for a redirection towards a focusing area. The wavelengths are such that glass containers formed of glass with different colors can be inspected using these three laser sources.

More particularly, the first wavelength of light is comprised between 440 and 490 nm and more preferably between 440 and 460 nm and even more preferably is of 450 nm (blue), the second wavelength of light is comprised between 495 and 570 nm and more preferably between 510 and 530 nm and even more preferably is of 520 nm (green), and the third wavelength of light is comprised between 620 and 750 nm, more preferably between 625 and 665 nm, more preferably between 630-650 nm and even more preferably is of 640 nm (red).

It appears in practice that such a light source is not suitable for inspecting in transmission a wide range of glass tints. In addition, the implementation of this light source is relatively complex by the means for combining several laser beams. Furthermore, this bulky light source can be exclusively implemented as a projector.

The “white field” observation is also known in particular for checking the appearance of the containers. According to this observation mode, the containers are caused to travel in translation between, on one side, one or several light sensors and, on the other side, a light source of the backlight panel type, preferably forming a diffuse light surface. The camera(s) perceive the light coming from the source and passing completely through the containers inspected from side to side. The light surface is of dimensions adapted to those of the container and to the type of inspection desired. The source can be uniform or have continuous or discontinuous, monotonous or periodic, slow or fast, spatial variations of the light level. For example, patent EP 1 143 237 describes a light source of the backlight panel type including a series of individually driven light-emitting diodes to light specific illumination areas with variations of light. In a complementary manner, the inspection in transmission of empty glass containers is also implemented in particular for checking the appearance of the bottom of the glass containers, reading codes carried by the glass containers or measuring the thickness of the wall of the glass containers.

For example, to read codes carried by the glass containers, patent application US 2006/092410 describes a device for inspecting in transmission containers including, according to a first embodiment, several light-emitting diodes and associated lenses focusing the light emitted by each of the diodes on the same region of the container to be inspected. According to another embodiment, the light-emitting diodes are mounted on a heat sink and are each associated with lenses so that the lights emitted by the diodes converge to be adjacent to each other on the lighted target surface. The light-emitting diodes have identical or different transmission wavelengths. These light-emitting diodes cannot be focused together at one point on the lighted object by means of a single lens, which would lead to shifts in the lighted regions. Such a device is not suitable for emitting light radiation suitable for the inspection in transmission of glass containers having a determined tint, without parasite.

In the state of the art, it is also known from US patent application 2009/0301765 to fix several light-emitting diodes on a printed circuit board using a thermally conductive adhesive paste. The light-emitting diodes have different emission wavelengths. Such a document does not provide a solution to the problem of parasite-free visual inspection of the containers adaptable to a wide range of glass tints. In addition, these light-emitting diodes cannot be simply focused together at a point on the lighted object by means of a single lens, which leads to shifts in the lighted regions.

The state of the art leads to the observation that the inspection in transmission of empty glass containers requires the implementation of different light sources to ensure particularly a dark field observation and a white field observation, these light sources must furthermore take into account in particular the spectral absorption of the glass in order to be able to inspect a wide range of container tints.

### DISCLOSURE OF THE INVENTION

The Applicant had the merit of expressing the need for a relatively universal device for inspecting in transmission glass containers with a wide range of different tints while allowing its implementation for a dark field observation and a white field observation.

The present invention aims to satisfy this need by proposing a new device for inspecting in transmission glass containers with different tints over a wide range while allowing its implementation for a dark field observation and a white field observation.

To achieve such an objective, the object of the invention relates to a device for inspecting glass-wall containers including at least one light source emitting light radiation in the direction of the container and comprising at least one driven elementary source, at least one light sensor collecting the light coming from the light source and having penetrated the wall of the container and which comes out from the container. According to the invention, at least one driven elementary source is constituted by a light-emitting diode with at least two dies mounted juxtaposed on a common support and emitting light radiation in different spectral emission bands which are a function of the transmission spectra of families of glass container tints, each spectral emission band of a die being limited to a spectral transmission band suitable for the inspection in transmission for at least one family of glass container tints, excluding the spectral absorption bands for this family of glass container tints and in that the device comprises an electronic power supply device independently controlling each die of each elementary source so that, for the inspection of glass containers belonging to a family of tints, the die emitting in the spectral emission band suitable for the inspection in transmission for the tint of said containers is controlled in emission.

According to one advantageous characteristic of the invention, a light-emitting diode has at least one die emitting light radiation in a spectral emission band comprised between 500 and 620 nm.

According to another advantageous characteristic of the invention, a light-emitting diode has at least one die emitting light radiation in a spectral emission band comprised between 700 and 1,000 nm.

According to another advantageous characteristic of the invention, a light-emitting diode has at least one die emitting light radiation in a spectral emission band comprised between 730 and 745 nm.

According to another advantageous characteristic of the invention, a light-emitting diode has at least one die emitting light radiation in a spectral emission band comprised between 830 and 870 nm.

According to another advantageous characteristic of the invention, a light-emitting diode has at least one die emitting light radiation in a spectral emission band comprised between 320 and 425 nm and preferably 370 and 390 nm.

According to one advantageous alternative embodiment, a light-emitting diode has four juxtaposed dies.

Preferably, the four-die light-emitting diode includes a first and a second die emitting light radiation in different spectral emission bands and a third and a fourth die emitting light radiation in the same spectral emission band which is different from the spectral emission bands of the first and second dies.

According to one preferred exemplary embodiment, the dies of the light-emitting diode are mounted on a common support to constitute an electronic component which is soldered to an electronic power supply and drive circuit to form a driven elementary source, the electronic power supply and drive circuit being itself connected to the electronic power supply device controlling the operation of the dies.

According to a first embodiment, the light source includes, in a casing, the electronic power supply and drive circuit and a projection optical system able to project the light emitted by the dies of the light-emitting diode so as to superimpose the areas lighted by the dies in a focusing region corresponding to a region of the container to be inspected.

According to a second embodiment, the light source comprises several driven elementary sources, mounted distributed on an electronic drive circuit board to form a one-dimensional or two-dimensional light source.

Another object of the invention relates to a method for inspecting in transmission glass-wall containers using at least one light source and at least one light sensor. According to the invention, the method comprises the following steps:
defining for at least two families of glass container tints, and for each of them, a spectral transmission band suitable for the inspection in transmission for the family of glass container tints and the spectral absorption bands for this family of glass container tints;
making available at least one elementary source including a light-emitting diode with at least two dies mounted juxtaposed on a common support and emitting light radiation in different spectral emission bands which are a function of the transmission spectra of the families of glass container tints, each spectral emission band of a die being limited to a spectral transmission band suitable for the inspection in transmission for at least one family of glass container tints, excluding the spectral absorption bands for this family of glass container tints;
controlling in emission, for the inspection of glass containers belonging to a family of tints, only the dies of each elementary source emitting in the spectral emission band suitable for the inspection in transmission of the containers of said family of tints;
and collecting by at least one light sensor, the light coming from the elementary source and having penetrated the wall of the container and which comes out from the container, in order to ensure the inspection of the containers.

To define the families of glass container tints:
the transmittance spectra of glass containers having similar tints are analyzed by identifying the maxima and the minima of the spectra;
at least some of these transmittance spectra are grouped together in a family of glass container tints for which are defined on the one hand at least one common spectral transmission band suitable for the inspection in transmission for the family of glass container tints and including a maximum and on the other hand, outside this or these spectral transmission band(s), the spectral absorption bands.

To make available at least one elementary source constituted by a light-emitting diode with at least two dies, the method consists in comparing the spectral transmission bands suitable for the inspection in transmission for different families of glass container tints so as to define for each die, a spectral emission band limited to a spectral transmission band suitable for the inspection in transmission for different families of container tints.

Advantageously, the spectral emission bands of the dies are chosen as a function of the spectral response curve of the light sensor.

According to one preferred characteristic of the method, the spectral emission bands of the at least two dies are chosen to include at least the two following spectral emission bands:
a spectral emission band comprised between 500 and 620 nm;
a spectral emission band comprised between 700 and 1,000 nm.

According to another preferred characteristic of the method, the spectral emission bands of the third and/or fourth dies are chosen to include at least one of the two following spectral emission bands:
a spectral emission band comprised between 830 and 870 nm;
a spectral emission band comprised between 370 and 390 nm.

Advantageously, the width of the spectral emission band of each die is less than 150 nm.

### BRIEF DESCRIPTION OF THE DRAWINGS

FIG. 1 is a schematic view of a first embodiment of a transmission inspection device in accordance with the invention whose light source is made in the form of a projector.

FIG. 2A is a schematic view of a light source implemented in an inspection device in accordance with the invention and provided with a projection optical system.

FIG. 2B is a schematic view of a light source implemented in an inspection device in accordance with the invention and provided with another projection optical system.

FIG. 3 is a schematic view of a light source not implementing the object of the invention and showing the projection obtained with three single-die light-emitting diodes.

FIG. 4 is a graphical representation of curves of the transmittance (in %) at a thickness of 2 mm of glass, as a function of the wavelength (in nm), for an example of a family of glass tints corresponding to the amber color.

FIG. 5 is a graphical representation of curves of the transmittance (in %) at a thickness of 2 mm of glass, as a function of the wavelength (in nm), for an example of a family of glass tints corresponding to the blue color.

FIG. 6 is a graphical representation of curves of the transmittance (in %) at a thickness of 2 mm of glass, as a function of the wavelength (in nm), for different tints of glass.

FIG. 7 is a graphical representation of the curve of the relative spectral power (P) of a light-emitting diode as a function of the wavelength (nm) showing the width PcL of the spectral emission band of a light-emitting diode taken at the mid-height of the peak of the lobe of the curve.

FIG. 8 is a graphical representation of the curve of the spectral response R (V/s/W/m²) as a function of the wavelength (nm) for an example of light sensor implemented in the device inspection in accordance with the invention.

FIG. 9A is a schematic plan view of a second embodiment of a transmission inspection device in accordance with the invention whose light source is made in the form of a backlight panel.

FIG. 9B is a schematic elevational sectional view of the second embodiment of the transmission inspection device in accordance with the invention illustrated in FIG. 9A.

### DESCRIPTION OF THE EMBODIMENTS

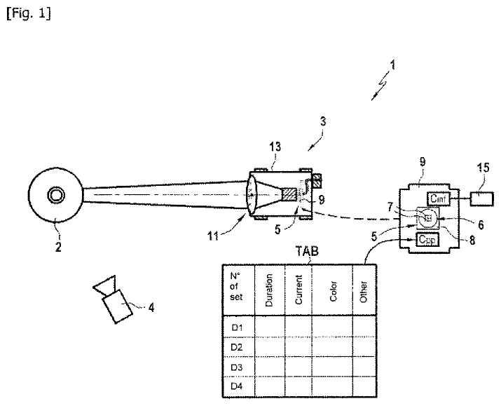

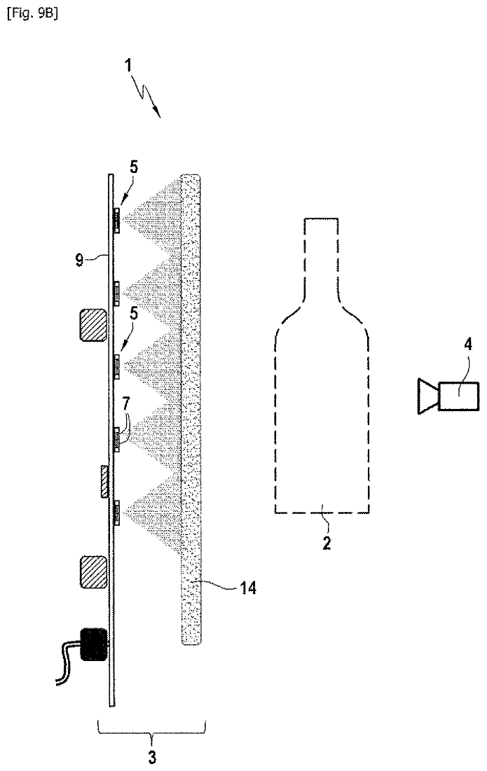

As appearing more particularly from FIGS. 1 and 9B, the object of the invention relates to a device 1 suitable for inspecting in transmission empty glass-wall containers 2 of all types such as bottles, jars or flasks for example. The inspection device 1 includes at least one light source 3 emitting light radiation in the direction of the container 2 and at least one light sensor 4 collecting the light coming from the light source 3 and having penetrated the wall of the container and which comes out from the container. It should be understood that the light sensor 4 collects the light coming from the light source having partially or completely crossed the wall of the container 2.

The inspection device 1 in accordance with the invention is suitable for inspecting in transmission glass-wall containers 2 in particular for checking the appearance of the containers, reading codes, for example datamatrix carried by the containers or measuring the thickness of the wall of the containers. The inspection device 1 in accordance with the invention is also suitable for inspecting in transmission containers 2 to detect defects such as surface cracks, plies or poor distribution of glass.

The light sensor 4 such as a camera can be of any type known per se, The light sensor 4 includes a photoelectric sensor, which may be for example of the CCD type or of the CMOS type, and a conditioning optical device which can include one or several optical components among optical lenses, mirrors, light guides (in particular optical fibers), fixed diaphragms such as masks or adjustable diaphragms such as iris diaphragms, etc.

The light source 3 includes at least one driven elementary light source 5 constituted by a light-emitting diode 6 with at least two juxtaposed dies 7 emitting light radiation in different spectral emission bands. The light-emitting diode 6 (LED) is an opto-electronic device capable of emitting light when it is traversed by an electric current. A light-emitting diode produces light radiation by converting electrical energy when a current passes therethrough.

According to the invention, each light-emitting diode 6 includes several dies 7, that is to say several PN junctions, so that the light-emitting diode 6 is a multi-die light-emitting diode. Each die 7 is a small rectangular piece resulting from the cutting of a wafer on which an integrated circuit has been manufactured. By extension, a die designates the integrated circuit itself without its casing and stands for electronic chip. The dies 7 are obtained by cutting the semiconductor wafers on which one or even several electronic circuits have been reproduced identically by a succession of different steps of photolithography, ion implants, deposition of thin layers, etc. Conventionally, each die 7 is a parallelepiped having an upper surface delimited by two longitudinal edges parallel to each other and connected by two side edges parallel to each other. Typically, the upper surface of a die 7 has a square or rectangular shape while the thickness of a die is less than one mm.

The dies 7 of the light-emitting diode 6 are mounted on a common support 8 to constitute an electronic component which forms the driven elementary source 5. This electronic component or driven elementary source 5 is soldered to an electronic power supply and drive circuit 9.

The dies 7 of the light-emitting diode 6 are mounted juxtaposed on the common support 8, that is to say the dies are placed close to each other. Typically, two dies 7 are juxtaposed if the neighboring or opposite edges of the two dies are separated by a gap of less than 0.5 mm and for example equal to 0.15 mm. According to one preferred exemplary embodiment illustrated in the drawings, the light-emitting diode 6 has four juxtaposed dies 7, that is to say two dies 7 located side by side and placed above close to a pair of dies 7 also located side by side.

For example, each die 7 has an upper surface having a length for example of 1 mm and a width for example of 1 mm. The four dies 7 of the light-emitting diode 6 present on the surface, a bulk for example, in length of 2.5 mm and in width of 2.5 mm. This bulk on the surface takes into account the gap remaining between the neighboring edges of the dies 7. Of course, the light-emitting diode 6 can include a different number of dies 7. Thus, the light-emitting diode 6 can include for example two juxtaposed dies 7 or three juxtaposed dies 7 having the same configuration as the example illustrated in the Figures with four dies, one of the dies 7 of which is deleted.

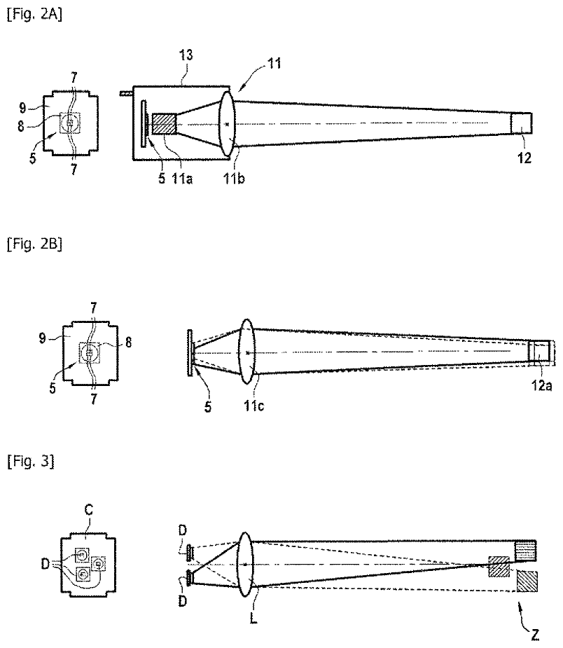

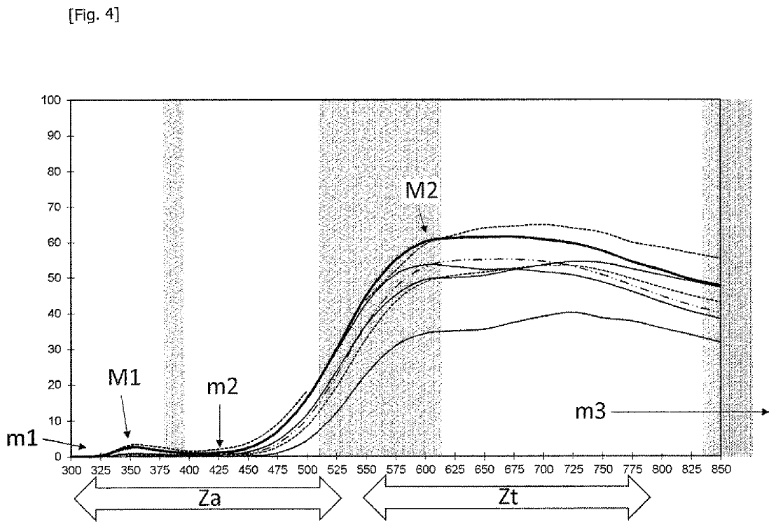

It is apparent from the description above that each multi-die 7 light-emitting diode 6 forms a quasi-point light source. According to a first embodiment of the transmission inspection device 1 in accordance with the invention illustrated in FIG. 1, the light source 3 includes a projection optical system 11 able to project the light emitted by the dies 7 of the light-emitting diode 6 so as to superimpose the areas lighted by the dies 7 in a focusing region 12 corresponding to a region of the container to be inspected (FIGS. 1 and 2A). According to this first embodiment, the light source 3 is a projector projecting an image of the light-emitting diode onto a region of the container to be inspected. Each multi-die 7 light-emitting diode 6 thus forms a quasi-point light source intended, by focusing, to emit a directional light beam that is to say a beam of light rays having a beam axis and whose rays are contained in a small solid angle around this beam axis.

According to this first embodiment, the light source 3 includes a casing 13 in which the electronic power supply and drive circuit 9 to which is soldered the common support 8 of the dies 7 of the light-emitting diode 6 is mounted. The casing 13 also includes the projection optical system 11 which can be made in any suitable way. In the example illustrated in FIGS. 1 and 2A, the projection optical system 11 includes a light guide 11a collecting the light emitted directly by the dies 7 and leading the collected light to a focusing lens lib which superimposes the areas lighted by the dies 7 in a focusing region 12. FIG. 2B illustrates an alternative embodiment of the projection optical system 11 which includes only one focusing lens 11c which superimposes the areas lighted by the dies 7 in a focusing region 12a having a common central area of superposition of the light coming from the four dies 7, with overflows of light around this common central area, the surface overflows being much smaller than the common central area, for example they represent less than 10% of the total lighted surface.

A comparison of FIGS. 2A and 2B with FIG. 3 clearly shows the interest of the driven elementary source 5 in accordance with the invention including the common support 8 on which the dies 7 of the light-emitting diode 6 are fixed. FIG. 3 shows an exemplary embodiment of a light source not implementing the invention and including three single-die light-emitting diodes D mounted close to each other on a common circuit C. The light emitted directly by the three dies of the three single-die light-emitting diodes D is collected by a focusing lens L analogous to the focusing lenses illustrated in FIGS. 2A and 2B. Insofar as this light source with three single-die light-emitting diodes D does not form a point or quasi-point light source, the areas lighted by the dies 7 are disjoint in the focusing region Z. Studies by the Applicant have shown that even with simple and compact light guides 11a, the configuration of FIG. 3 does not allow the superposition of the lightings of the different dies via a lens 11b, in the focusing region.

Thus, the driven elementary source 5 in accordance with the invention can be implemented in a first embodiment for which the light source 3 is a projector. It should be noted that the driven elementary source 5 in accordance with the invention can be implemented in a second embodiment for which the light source 3 is a backlight panel. According to this second embodiment illustrated in FIGS. 9A and 9B, several driven elementary sources 5 are soldered to an electronic power supply and drive circuit 9 in front of which a diffusing plate 14 is generally placed. The light source 3 thus comprises several driven elementary sources 5, mounted on the electronic power supply and drive circuit by being distributed on this circuit to form a one-dimensional or two-dimensional light source.

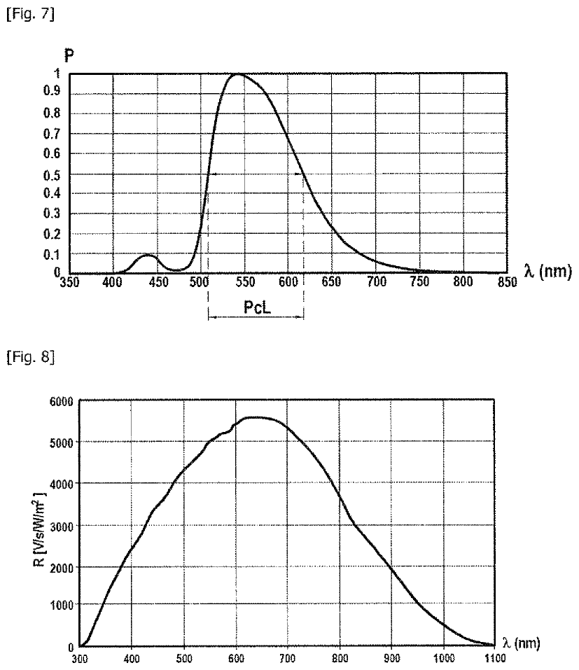

Each die 7 of the light-emitting diode 6 emits light radiation in a determined spectral emission band. In other words, the dies 7 are selected or manufactured to produce lightings suitable for the inspection in transmission of glass containers in a wide range of tints. As illustrated in FIG. 7, the width PcL of the spectral emission band of a light-emitting diode is taken at the mid-height of the peak of the lobe of the curve of the relative spectral power P as a function of the wavelength A (nm).

In accordance with the invention, each spectral emission band of a die 7 is limited to a spectral transmission band Zt suitable for the inspection in transmission for at least one family of glass container tints, excluding the spectral absorption bands Za for this family of glass container tints.

According to one advantageous characteristic of the invention, the width PcL of the spectral emission band of each die 7 is less than 150 nm. It is thus easy for each spectral emission band of a die 7 to be limited to a spectral transmission band Zt suitable for the inspection in transmission for at least one family of glass container tints, while excluding the spectral absorption bands Za for this family of glass container tints.

It is recalled that the spectral absorption of glass A(A) is a function of the wavelength giving the % of light absorbed per mm of traversed glass. To compare the absorption of glasses in different portions of the spectrum, the absorption of 2 or 3 mm glass slides is generally measured. The spectral absorption defines the tints of the lens accurately. It is also possible to compare for a given lens, the different portions of the spectrum: for example, it is possible to distinguish portions of the spectrum that are little absorbed (almost 0% for 2 mm) or strongly absorbed (almost 100%). The same reasoning applies to the transmission T(λ)=1−A(λ) ouT(λ)%=100−A(λ)%.

FIG. 4 gives an example of the transmittance curves (in %) at a thickness of 2 mm of glass, as a function of the wavelength (in nm), for a family of glass tints corresponding to the amber color. This FIG. 4 puts together seven examples of transmittance curves for close glass container tints belonging to the amber tint. These transmittance spectra that have been grouped together show common profiles or concurrent evolution. Thus, these curves have a first transmittance maximum M1 framed by a first minimum m1 and by a second minimum m2 and a second transmittance maximum M2 framed by the second minimum m2 and a third minimum m3. Even if the transmittance values are different for the minima and maxima of these different tints, these minima and maxima can be defined for determined values of the wavelength.

The object of the invention is to seek the maximum quantity of light having passed through the container while not emitting in the absorbed wavelengths which are useless and likely to affect the quality of the inspection. It should be noted that the transmittance of the glass is to be considered in a relative way because the maximum of the transmittance for a tint of glass can be low as for a dark glass but remains not negligible compared to the rest of the spectrum.

For the family of container tints qualified as amber, at least one spectral transmission band Zt suitable for the inspection in transmission for the family of glass container tints and at least one spectral absorption band Za for this family of glass container tints are defined. The spectral transmission band Zt comprises a maximum and advantageously the maximum having the greatest transmittance value, namely the maximum M2. For example, the spectral transmission band Zt is comprised between 550 nm and 800 nm while the spectral absorption band Za is comprised between 300 and 525 nm.

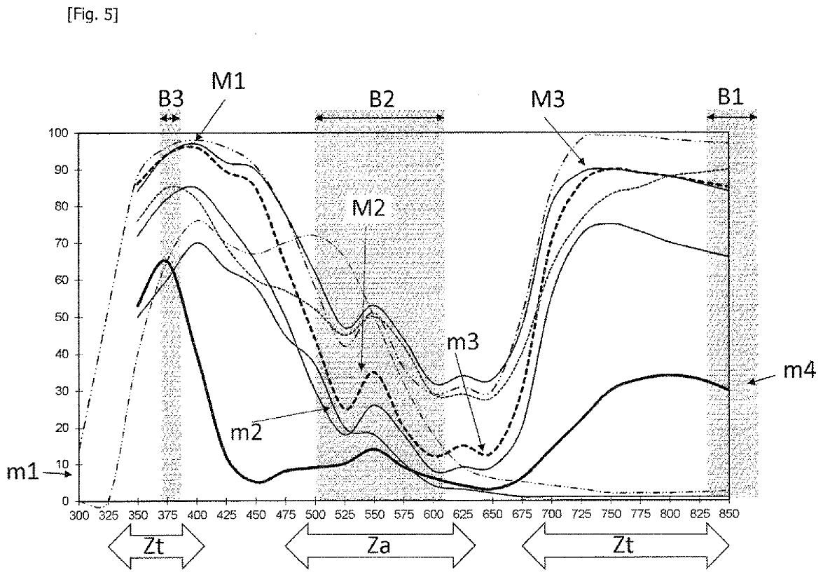

Similarly, FIG. 5 gives an example of curves of transmittance (in %) at a thickness of 2 mm of glass, as a function of the wavelength (in nm), for an example of a family of glass tints corresponding to the blue color. This FIG. 5 brings together eight examples of transmittance curves for close glass container tints belonging to the blue tint. These transmittance spectra that have been grouped together show common profiles or concurrent evolution. Thus, these curves present a first M1, a second M2 and a third M3 maximum of transmittance each framed by a pair of minima respectively m1-m2, m2-m3 and m3-m4. Even if the transmittance values are different for the minima and maxima of these different tints, these minima and maxima can be defined for determined values of the wavelength. For this family of container tints qualified as blue, two spectral transmission bands Zt suitable for the inspection in transmission for the family of glass container tints are defined, including the first M1 and the third M3 maxima and a spectral absorption band Za for this family of glass container tints (including the second maximum M2), It is thus possible to define a first spectral transmission band Zt comprising the first maximum M1 but also a second spectral transmission band Zt comprising the third maximum M3 whose transmittance value, although lower than the value of the first maximum, can be suitable for an inspection in transmission. For example, the spectral transmission bands Zt are comprised between 325 nm and 410 nm and between 675 and 850 nm while the spectral absorption band Za is comprised between 475 and 630 nm.

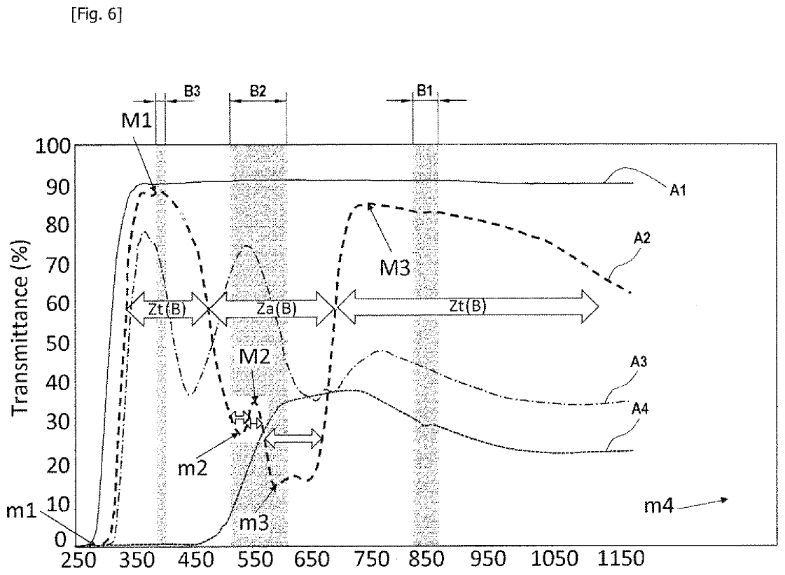

FIG. 6 illustrates by way of example the curves of the transmittance at a thickness of 2 mm of glass, as a function of the wavelength, for different families of glass tints A1, A2, A3, A4 corresponding respectively to extra white, blue, green and amber glass. Also, as a function of the transmittance for different families of glass tints, the spectral emission bands of the dies 7 of a light-emitting diode are chosen. As explained in relation to FIGS. 4 and 5, each spectral emission band of a die 7 is limited to a spectral transmission band suitable for the inspection in transmission for at least one family of glass container tints, excluding the spectral absorption bands for this family of glass container tints.

The analysis of the transmittance spectra for a large number of glass tints made it possible to define the spectral bands of the dies 7 of a light-emitting diode 6. In FIG. 6, the three spectral bands B1, B2, B3 of three dies 7 of a light-emitting diode 6 have been represented by way of example.

According to one advantageous alternative embodiment, the light-emitting diode 6 has at least one die 7 emitting light radiation in a spectral emission band comprised between 500 and 620 nm with a central value at 565 nm. The light emitted by such a die 7 is particularly suitable for the inspection of glasses with tints classified in the green category (curve A3) corresponding to amber, oak, dead leaves, green tints for example.

According to another advantageous alternative embodiment, the light-emitting diode 6 has at least one die 7 emitting light radiation in a spectral emission band comprised between 700 and 1,000 nm. Advantageously, the light-emitting diode 6 has at least one die 7 emitting light radiation in a spectral emission band comprised between 730 and 745 nm with a central value at 740 nm. The light emitted by such a die 7 is particularly suitable for the inspection of glasses with tints classified in the blue category (curve A2) and the amber category (curve A4) corresponding to blue or oak amber tints for example.

Advantageously, the light-emitting diode 6 has at least one die 7 emitting light radiation in a spectral emission band comprised between 830 and 870 nm with a central value at 850 nm. The light emitted by such a die 7 is particularly suitable for the inspection of glasses with tints classified in the blue category (curve A2) corresponding to dark tints such as black, purple, dark grey, blue or green tints for example.

Advantageously, the light-emitting diode has at least one die 7 emitting light radiation in a spectral emission band comprised between 320 and 425 nm and preferably 370 and 390 nm with a central value at 385 nm. The light emitted by such a die 7 is particularly suitable for the inspection of glasses with tints classified in the blue category (curve A2) or the green category (curve A3) corresponding to dark tints such as blue or green tints for example.

According to one alternative embodiment, the light-emitting diode 6 includes at least two dies 7 chosen to include at least the two following spectral emission bands:
a spectral emission band comprised between 500 and 620 nm;
a spectral emission band comprised between 700 and 1,000 nm.

According to another alternative embodiment, the light-emitting diode 6 includes three or four dies 7. Advantageously, the spectral emission bands of a third and/or fourth die(s) 7 are chosen to include at least one of the two following spectral emission bands:
a spectral emission band comprised between 830 and 870 nm;
a spectral emission band comprised between 370 and 390 nm.

According to another alternative embodiment, the light-emitting diode 6 has four dies 7 including a first die and a second die emitting light radiation in different spectral emission bands and a third and a fourth die emitting light radiation in the same spectral emission band which is different from the spectral emission bands of the first and second dies. Such an alternative embodiment allows increasing the power of the light radiation in a specific spectral emission band corresponding to the inspection of widespread glass tints.

It should be understood that the light-emitting diode 6 can include several dies 7 associated so as to emit light radiation in at least two different spectral emission bands, with some of the dies being able to emit light radiation in identical spectral emission bands.

Thus, according to one exemplary embodiment, a four-die 7 light-emitting diode 6 can include:
a first and a second die 7 emitting a spectral emission band comprised between 500 and 620 nm;
a third die 7 emitting a spectral emission band comprised between 830 and 870 nm;
a fourth die 7 emitting a spectral emission band comprised between 730 and 745 nm.

According to another exemplary embodiment, a four-die 7 light-emitting diode 6 can include:
a first and a second die 7 emitting a spectral emission band comprised between 500 and 620 nm;
a third and a fourth die 7 emitting a spectral emission band comprised between 830 and 870 nm.

According to another exemplary embodiment, a four-die 7 light-emitting diode 6 can include:
a first die 7 emitting a spectral emission band comprised between 500 and 620 nm;
a second die 7 emitting a spectral emission band comprised between 830 and 870 nm;
a third die 7 emitting a spectral emission band comprised between 730 and 745 nm;
a fourth die 7 emitting a spectral emission band comprised between 370 and 390 nm.

According to another characteristic of the object of the invention, the inspection device 1 comprises an electronic power supply device 15 independently controlling each die 7 of each elementary source 6 so that, for the inspection of glass containers belonging to a family of tints, the die(s) 7 emitting in the spectral emission band suitable for the inspection in transmission for the tint of said containers is controlled in emission. Thus, for the inspection in transmission of a batch of containers having a determined tint, the electronic power supply device 15 drives the operation of the die(s) 7 having the transmittance spectra adapted to this glass tint and only this or these die(s) 7. It follows that the light source 3 emits light radiation in a limited spectrum suitable for the inspection in transmission without emitting wavelengths absorbed by the glass. Of course, for the inspection in transmission for a batch of containers having a different tint, the electronic power supply device 15 drives the operation of the die(s) 7 having the transmittance spectra adapted to this new glass tint and only this or these die(s) 7. Thus, the inspection in transmission for containers having different tints can be carried out without changing the light source 3.

It appears from the foregoing description that the choice and the selection of the spectral emission bands of the dies 7 of the light-emitting diode allows increasing the quantity of light having partially or completely passed through the wall of the container and consequently, increasing the quality of the signal from the light sensor 4. By excluding the spectral absorption bands for the tint of the containers inspected, the wavelengths likely to interfere with the inspection of the containers are not emitted. This particularly avoids the appearance of parasites by reflection on the glass during the detection of surface cracks by light sources 3 of the projector type (FIG. 1).

Likewise in the case of the inspection of the containers by a light source 3 of the backlight panel type (FIGS. 9A, 9B), this avoids the creation of the effect of blooming or dazzling of the sensor by a background view of a part of the directly visible backlight panel. Indeed, particularly for containers made of dark and/or thick glass, the light source must emit energy strong enough to pass through two glass walls. The field of view of a camera 4 as illustrated in FIG. 98 allows producing an image of the container that does not fill 100% of the field. The image is therefore composed of a container image area, surrounded by a region in which the camera directly sees the light source larger than the container, called source image area. The light arriving in the container image area reaches the sensor by passing through the container, undergoing the spectral absorption of the glass. The light arriving in the source image area is not absorbed whatever its spectrum. Thanks to the emission in the spectral transmission band Zt of the glass, a sufficient quantity of light will be received for the container image area in order to produce an image to be analyzed, for example to detect defects refracting or absorbing the transmitted light. In the source image area, the light coming from the light source and emitted in the spectral transmission band Zt will not be absorbed but, without the invention, the light emitted in the absorption band Za which would not be absorbed either since it would not pass through the container would be added. The cumulative light energy in the bands Za and Zt then risks saturating the pixels of the sensor in the source image area, therefore the regions of the image outside the container. This saturation would make an accurate detection of the contours of the containers impossible, and in particular would prohibit a subpixel determination in the images for the dimensional checks. The saturation could cause halos in the image and also a risk of smearing if the sensor was CCD technology. In addition, since the containers are generally traveling on a conveyor, the light emitted in the absorption band Za, useless for the detection in transmission, could increase the energy and the risk of parasitic reflections of the light emitted reflecting from one container to another, these reflections possibly being misinterpreted to lead to false rejections or, conversely, prevent the analysis of portions of containers masking potential defects.

Other advantages appear when the light source 3 forms a projector according to the first embodiment. In the application to the detection of surface cracks, generally a series of projectors is implemented in association with one or several light sensors 4. The switching on and off of these projectors is electrically controlled by the electronic power supply system 15. Thus, the duration of an emitted light pulse as well as optical characteristics such as intensity or spectral composition or color characteristics of the emitted light can be electrically checked.

The illumination parameters of the projectors 3 comprise for example:
a delay or time limit between the trigger signal and the beginning of the illumination and/or,
an illumination time, which is the duration during which the light is emitted and/or,
the activation or the non-activation of the projector in response to a trigger signal and/or, an intensity of light emitted in the case of a monochrome projector,
several light intensity values emitted in the case of a polychrome projector by combination of elementary sources of different colors.

The set of the illumination parameters constitutes a set of illumination parameters of a projector that can be put together in a table TAB of sets J1, J2, J3, . . . of acquisition parameters, as illustrated in FIG. 1. Thus, the illuminations of a projector for each container which are successive or distant in time can be carried out with different sets of illumination parameters. This allows for example switching on some projectors and not others during all image acquisitions by a light sensor, or even adapting the incident light energy as a function of the illuminated or inspected regions, or even groups of projectors can light the same area in different numbers depending on the type of image to be produced and/or the associated light sensor.

The electronic power supply and drive circuit 9 of each projector includes a circuit Cpp checking, for example, the storage, the charge and the discharge of the electrical energy in the dies of the light-emitting diode 6. For example the storage of electric charge is a capacity. Each projector is connected to an electrical power supply and to the electronic power supply system 15 by a connection, for example wired connection, via an interface circuit Cint. A network is organized to link all the projectors to the electronic power supply system 15. The connection operates according to a bus-type communication protocol, allowing the electronic power supply system to separately address each projector or each set of projectors to provide it with at least one set of illumination parameters and a trigger signal. The electronic power supply and drive circuit 9 of each projector or set of projectors contains a memory able to record a list or a table of several successive sets of illumination parameters, and a sequencer such that at each trigger signal, the applied set of illumination parameters corresponds to the next set in the list.

The electronic power supply system 15, in a starting or adjustment phase of the inspection, programs or records for each projector, an equal number of successive sets of illumination parameters. Then, for each container, depending on the displacement of the container in an inspection area, the electronic power supply system triggers the image acquisitions and the illuminations by sending a trigger signal to each light sensor and each projector. The sending of a single common trigger signal to all the projectors for each incremental displacement of the container can also be envisaged. Sets of parameters indicating not to illuminate the projector on a trigger signal are provided in the lists of sets of illumination parameters. Thus, the projectors are only lighted to contribute to specific conditions of illumination of a region of the container for an observation by a given light sensor in order to detect given defects.

The object of the invention is also advantageous when the light source 3 is of the backlight panel type. According to this second implementation, the density of driven elementary sources 5 placed on a panel is greater than the density obtained by single-die diodes, having different spectral emission bands and distributed over such a panel. In addition, thanks to driven elementary sources 5 at different spectral emission bands, it follows that the different optical configurations such as patterns, power variations and shapes generated by the backlight panel are the same whatever the composition of the chosen wavelengths (simultaneous activation of one or several dies 7). This light source also allows creating a backlight source with spatial variations of the color, by creating for example a color gradient or alternating color stripes.

Another object of the invention is to propose a new method for inspecting in transmission glass-wall containers 2 using at least one light source 3 and at least one light sensor 4. The method comprises the following steps:
defining for at least two families of glass container tints, and for each of them, a spectral transmission band suitable for the inspection in transmission for the family of glass container tints and the spectral absorption bands for this family of glass container tints;
making available at least one elementary source 3 including a light-emitting diode 6 with at least two juxtaposed dies 7 emitting light radiation in different spectral emission bands which are a function of the transmission spectra of the families of glass container tints, each spectral emission band of a die being limited to a spectral transmission band Zt suitable for the inspection in transmission for at least one family of glass container tints, excluding the spectral absorption bands Za for this family glass container tints;
controlling in emission, for the inspection of glass containers belonging to a family of tints, only the dies 7 of each elementary source emitting in the spectral emission band suitable for the inspection in transmission of the containers of said family of tints;
and collecting by at least one light sensor 4, the light coming from the elementary source 3 and having penetrated the wall of the container and which comes out from the container, in order to ensure the inspection of the containers.

To define the families of glass container tints:
the transmittance spectra of glass containers with similar tints are analyzed by identifying the maxima M1, M2, M3, . . . and the minima m1, m2, m3, m4, . . . of the spectra as explained in relation to FIGS. 4 and 5;
at least some of these transmittance spectra are grouped together in a family of glass container tints for which are defined on the one hand, at least one common spectral transmission band suitable for the inspection in transmission for the family of glass container tints and including a maximum and on the other hand, outside this or these spectral transmission band(s), the spectral absorption bands.

According to one advantageous characteristic, the method consists in comparing the spectral transmission bands suitable for the inspection in transmission for different families of glass container tints so as to define for each die 7, a spectral emission band limited to a spectral transmission band Zt suitable for the inspection in transmission for different families of container tints, so as not to contain any spectral absorption band Za.

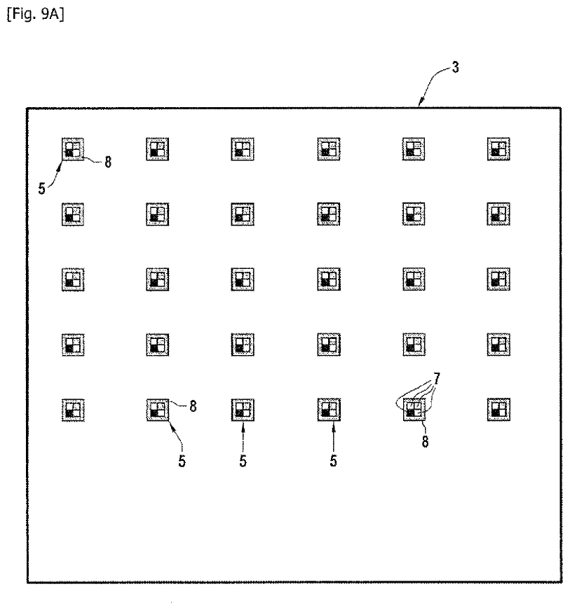

As explained above, the dies 7 are selected according to the transmittance spectra of the different glass tints of the containers to be inspected. Advantageously, the spectral emission bands of the dies 7 are also chosen as a function of the spectral response curve of the light sensor 4, an example of which is given in FIG. 8. This allows perfecting the choice of the spectral emission bands of the dies 7 so that the light sensor 4 has good sensitivity for the chosen spectral emission bands.

Such a transmission inspection method can be implemented to detect, in particular, surface cracks on containers by the projectors. By the light source made by the backlighting panel, it is possible to implement in particular, a check of the appearance of the containers to detect absorbent or strongly refracting defects, checks of the appearance with light gradient, a check of the stress defects by a polarized light, a reading of the codes carried by the containers.

1. A device for inspecting in transmission glass-wall containers (2) including at least one light source (3) emitting light radiation in the direction of the container and comprising at least one driven elementary source (5), at least one light sensor (4) collecting the light coming from the light source and having penetrated the wall of the container and which comes out from the container, characterized in that at least one driven elementary source (5) is constituted by a light-emitting diode (6) with at least two dies (7) mounted in a juxtaposed manner on a common support (8) and emitting light radiation in different spectral emission bands which are a function of the transmission spectra of families of glass container tints, each spectral emission band of a die being limited to a spectral transmission band (Zt) suitable for the inspection in transmission for at least one family of glass container tints, excluding the spectral absorption bands (Za) for this family of glass container tints and in that the device comprises an electronic power supply device (15) independently controlling each die (7) of each elementary source (3) so that, for the inspection of glass containers belonging to a family of tints, the die (7) emitting in the spectral emission band suitable for the inspection in transmission for the tint of said containers is controlled in emission.

2. The device according to claim 1, according to which a light-emitting diode (6) has at least one die (7) emitting light radiation in a spectral emission band comprised between 500 and 620 nm.

3. The device according to claim 1, according to which a light-emitting diode (6) has at least one die (7) emitting light radiation in a spectral emission band comprised between 700 and 1,000 nm.

4. The device according to claim 1, according to which a light-emitting diode (6) has at least one die (7) emitting light radiation in a spectral emission band comprised between 730 and 745 nm.

5. The device according to claim 1, according to which a light-emitting diode (6) has at least one die (7) emitting light radiation in a spectral emission band comprised between 830 and 870 nm.

6. The device according to claim 1, according to which a light-emitting diode (6) has at least one die (7) emitting light radiation in a spectral emission band comprised between 320 and 425 nm and preferably 370 and 390 nm.

7. The device according to claim 1, according to which a light-emitting diode (6) has four juxtaposed dies (7).

8. The device according to claim 7, according to which the four-die (7) light-emitting diode (6) includes a first and a second die (7) emitting light radiation in different spectral emission bands and a third and a fourth die (7) emitting light radiation in the same spectral emission band which is different from the spectral emission bands of the first and second dies.

9. The device according to claim 1, according to which the dies (7) of the light-emitting diode (6) are mounted on a common support (8) to constitute an electronic component which is soldered to an electronic power supply and drive circuit (9) to form a driven elementary source, the electronic power supply and drive circuit (9) being itself connected to the electronic power supply device (15) controlling the operation of the dies (7).

10. The device according to claim 9, according to which the light source (3) includes, in a casing (13), the electronic power supply and drive circuit (9) and a projection optical system (11) able to project the light emitted by the dies (7) of the light-emitting diode so as to superimpose the areas lighted by the dies (7) in a focusing region corresponding to a region of the container to be inspected.

11. The device according to claim 1, according to which the light source (3) comprises several driven elementary sources (5), mounted distributed on an electronic drive circuit board to form a one-dimensional or two-dimensional light source.

12. A method for inspecting in transmission glass-wall containers (2) using at least one light source (3) and at least one light sensor (4), the method comprising the following steps:
defining for at least two families of glass container tints, and for each of them, a spectral transmission band suitable for the inspection in transmission for the family of glass container tints and the spectral absorption bands for this family of glass container tints;
making available at least one elementary source (3) including a light-emitting diode (6) with at least two dies (7) mounted juxtaposed on a common support (8) and emitting light radiation in different spectral emission bands which are a function of the transmission spectra of the families of glass container tints, each spectral emission band of a die being limited to a spectral transmission band (Zt) suitable for the inspection in transmission for at least one family glass container tints, excluding the spectral absorption bands (Za) for this family of glass container tints;
controlling in emission, for the inspection of glass containers belonging to a family of tints, only the dies (7) of each elementary source emitting in the spectral emission band suitable for the inspection in transmission of the containers of said family of tints;
and collecting by at least one light sensor (4), the light coming from the elementary source (3) and having penetrated the wall of the container and which comes out from the container, in order to ensure the inspection of the containers.

13. The method according to claim 12, according to which in order to define the families of glass container tints:
the transmittance spectra of glass containers having similar tints are analyzed by identifying the maxima and the minima of the spectra;
at least some of these transmittance spectra are grouped together in a family of glass container tints for which are defined on the one hand at least one common spectral transmission band suitable for the inspection in transmission for the family of glass container tints and including a maximum and on the other hand, outside this or these spectral transmission band(s), the spectral absorption bands.

14. The method according to claim 12, according to which in order to make available at least one elementary source (3) constituted by a light-emitting diode (6) with at least two dies (7), the method consists in comparing the spectral transmission bands suitable for the inspection in transmission for different families of glass container tints so as to define for each die, a spectral emission band limited to a spectral transmission band suitable for the inspection in transmission for different families of container tints.

15. The method according to claim 12, according to which the spectral emission bands of the dies (7) are chosen as a function of the spectral response curve of the light sensor (4).

16. The method according to claim 12, according to which the spectral emission bands of the at least two dies (7) are chosen to include at least the two following spectral emission bands:
a spectral emission band comprised between 500 and 620 nm;
a spectral emission band comprised between 700 and 1,000 nm.

17. The method according to claim 16, according to which the spectral emission bands of the third and/or fourth dies (7) are chosen to include at least one of the two following spectral emission bands:
a spectral emission band comprised between 830 and 870 nm;
a spectral emission band comprised between 370 and 390 nm.

18. The method according to claim 12, according to which the width (PcL) of the spectral emission band of each die (7) is less than 150 nm.
